(19) United States
(12) Patent Application Publication
(10) Pub. No.: US 2026/0169977 A1
(43) Pub. Date: Jun. 18, 2026

(54) SYSTEMS AND METHODS FOR ARTIFICIAL INTELLIGENCE AGENTS FOR FACTUAL CONSISTENT GENERATION

(71) Applicant: Salesforce, Inc., San Francisco, CA (US)

(72) Inventors: Onkar Thorat, Palo Alto, CA (US); Philippe Laban, New York, NY (US); Chien-Sheng Wu, Mountain View, CA (US)

(21) Appl. No.: 19/188,720

(22) Filed: Apr. 24, 2025

Related U.S. Application Data
(60) Provisional application No. 63/734,160, filed on Dec. 15, 2024.

(51) Int. Cl. G06F 16/23; G06N 3/084

(52) U.S. Cl. CPC G06F 16/2365; G06N 3/084

(57) ABSTRACT

Embodiments described herein provide a method for enhancing factual consistency of an artificial intelligence (AI) agent. The method includes obtaining a first dataset of documents and corresponding seed summaries; generating, by a first neural network based language model, inconsistent summaries by replacing texts in one or more seed summaries; forming a second dataset of documents and corresponding inconsistent summaries for evaluating a second neural network based language model; and generating, by the second neural network based language model, a detection of a factual inconsistency and/or an explanation of the factual inconsistency. The method further includes generating, by a third neural network based language model, an evaluation score indicating an accuracy level of the detected factual inconsistency based at least in part on the explanation; and building, at a server the AI agent employing the second neural network based language model when the evaluation score is greater than a threshold.

### CROSS REFERENCE(S)

The instant application is a nonprovisional of and claim priority under 35 U.S.C. 119 to U.S. provisional application no. 63/734,160, filed Dec. 15, 2024, which is hereby expressly incorporated by reference herein in its entirety.

### TECHNICAL FIELD

The embodiments relate generally to machine learning systems for content generation, and more specifically to systems and methods for artificial intelligence (AI) agents for factual consistent generation.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. As neural network models generate text by predicting the most likely next word based on patterns in their training data, often do not fact-check against a knowledge base or external source in real time, model-generated text can sometimes be factually inconsistent. It remains challenging for LLMs to detect factual inconsistencies in their own generated text because they often lack robust mechanisms to accurately compare the output against the contextual information or source documents from which the facts should be derived.

### BRIEF DESCRIPTION OF THE DRAWINGS

FIG. 1 shows an exemplary application of an AI agent, according to some embodiments.

FIGS. 2A-2C show simplified diagrams illustrating operations associated with a consistency enhancement framework for enhancing factual consistency of an AI agent, according to some embodiments.

FIG. 2D shows an example of an executable input prompt used in the consistency enhancement framework, according to some embodiments.

FIG. 3A is a simplified diagram illustrating a computing device implementing the consistency enhancement framework described in FIGS. 2A-2D, according to some embodiments.

FIG. 3B is a simplified diagram illustrating a neural network structure, according to some embodiments.

FIG. 4 is a simplified block diagram of a networked system suitable for implementing the consistency enhancement framework described in FIGS. 2A-2D, 3A, and 3B and other embodiments described herein.

FIG. 5 is an example logic flow diagram illustrating a method of enhancing factual consistency of an AI agent based on the framework shown in FIGS. 2A-2D, 3A, and 3B, and 4, according to some embodiments.

FIGS. 6A-6D provide charts illustrating exemplary performance of different embodiments described herein.

FIGS. 7A-7D shows examples of certain input prompts, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

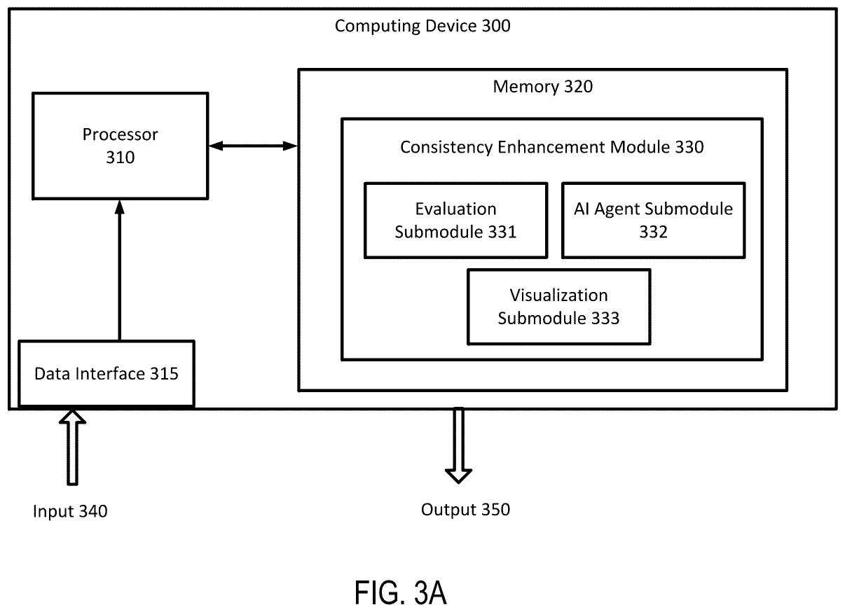

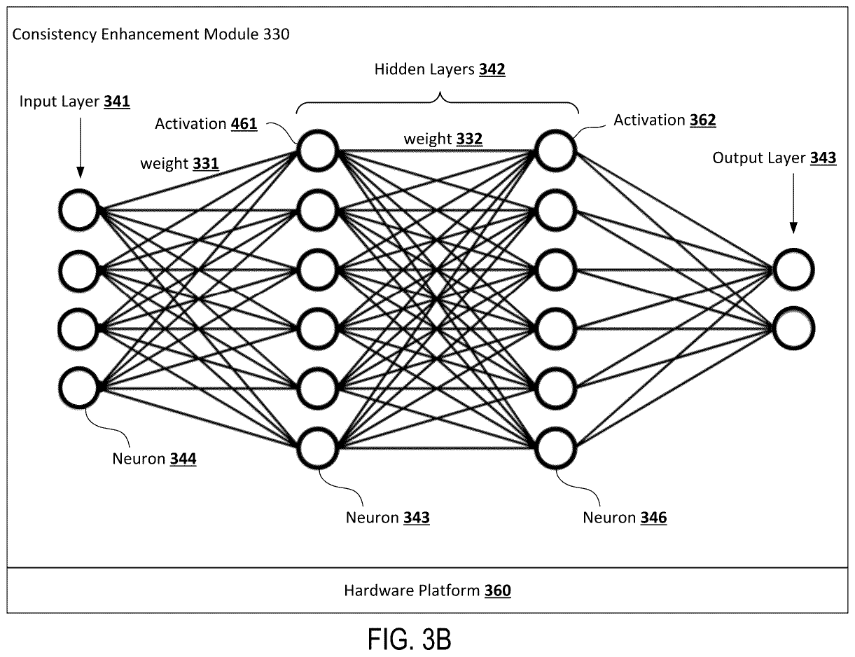

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Large language model (LLM) can be used for generating answers to queries. However, texts generated by these LLMs may contain factual inaccuracies and hallucinations, and thus cause risks in practical applications, e.g., dissemination of misinformation, false diagnostics, and/or the like. It remains challenging for LLM to detect whether an LLM-generated text contains factual inconsistency based on context information or a source document. Some systems may generate human-edited text samples for evaluating the LLM's ability to detect factual inconsistencies often include trivial and unpredictable changes, making the evaluation less effective.

In view of the need for enhancing an LLM's ability to detect and explain factual inconsistencies, embodiments described herein provide a consistency enhancement framework that generates an evaluation dataset (e.g., a benchmark dataset) for evaluating an LLM's ability to detect and/or explain factual inconsistencies, and employs the LLM with desirably high ability as an AI agent, enhancing the factual consistency of the AI agent built on the LLM. For example, a seed dataset of a plurality of documents and corresponding seed summaries are obtained, e.g., by using a pretrained summarization models to generate summaries of a dataset of documents. An LLM may then be used to generate at least one or more inconsistent summaries from the seed summaries, e.g., by replacing texts in one or more seed summaries. Specifically, executable editing is used to create the inconsistent summaries to control the content and location of the edits. For example, the texts are replaced using executable prompts to precisely insert known factual inconsistency. The inconsistent summaries can thus be more controllable and predictable, and the evaluation of the LLM can be more accurate. The factual consistency of the AI agent built based on the LLM can be improved.

In this way, the original documents and corresponding inconsistent summaries form an evaluation dataset for evaluating LLMs on their factual consistency. For example, given an LLM, the LLM is given a prompt of a document, a generated inconsistent summary to generate a detection of a factual inconsistency and/or an explanation of the factual inconsistency. An evaluation score may be assigned indicating an accuracy level of the detected factual inconsistency based at least in part on the explanation.

In this way, LLMs with high evaluation scores may be selected for building an AI agent, e.g., when the evaluation score is greater than a threshold.

In another implementation, the detected factual inconsistency may be compared with a ground-truth inconsistency (stored with the generation of the inconsistent summary) to compute a loss, which is used to train the LLM so as to enhance its factual consistency.

Embodiments described herein provide a number of benefits. For example, AI agents that generate content/text, such as AI-assisted chatbots based on the LLM passed the evaluation, can have improved factual consistency. Therefore, with improved performance on AI agents, neural network technology in fields such as network issue support, healthcare, and the like, is improved.

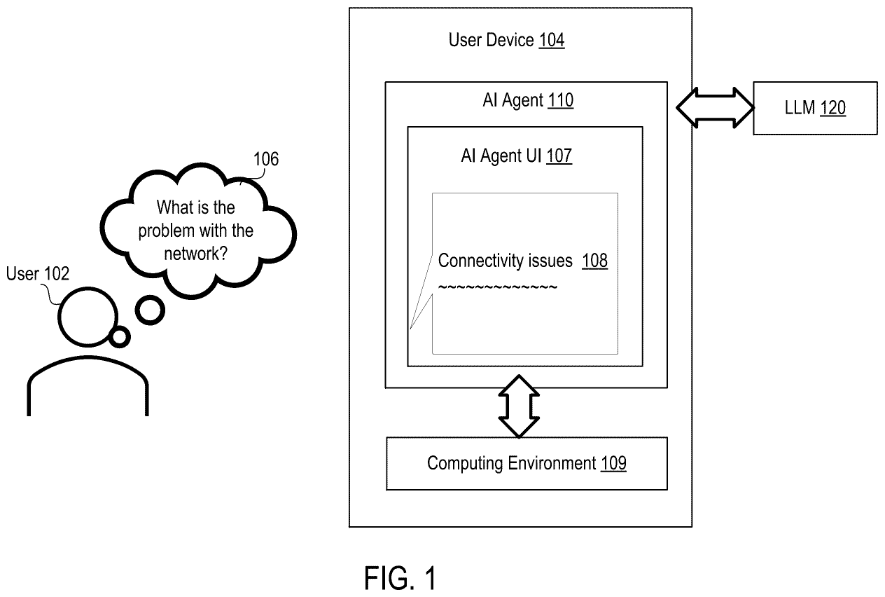

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “What is the problem with the network” 106.

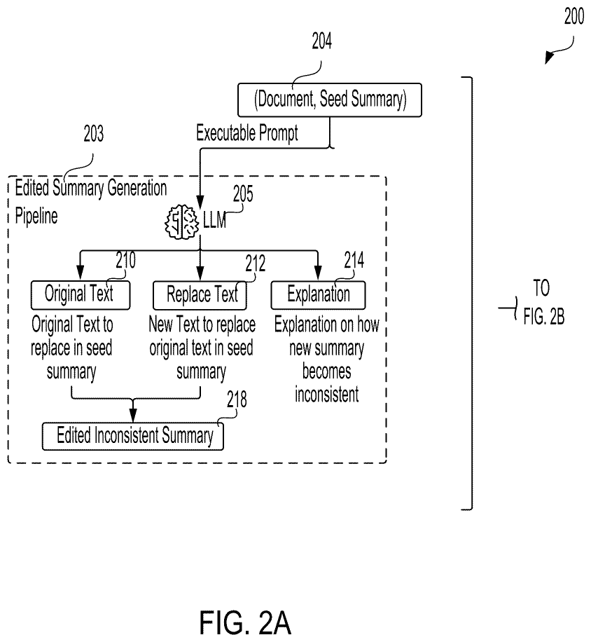

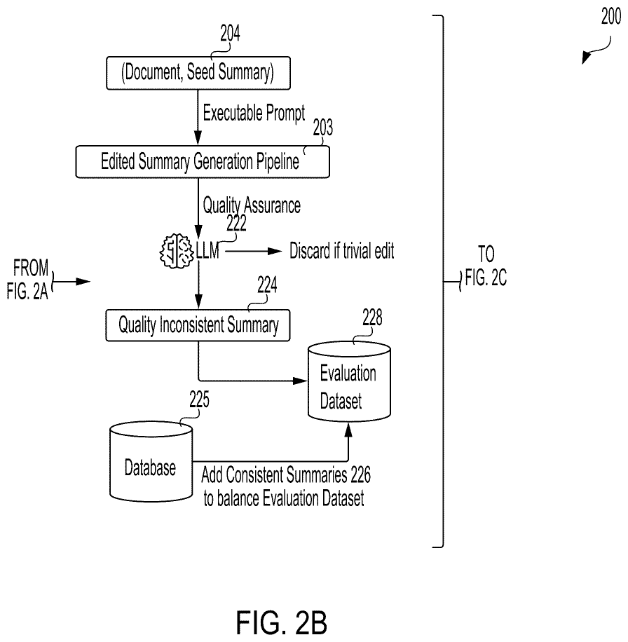

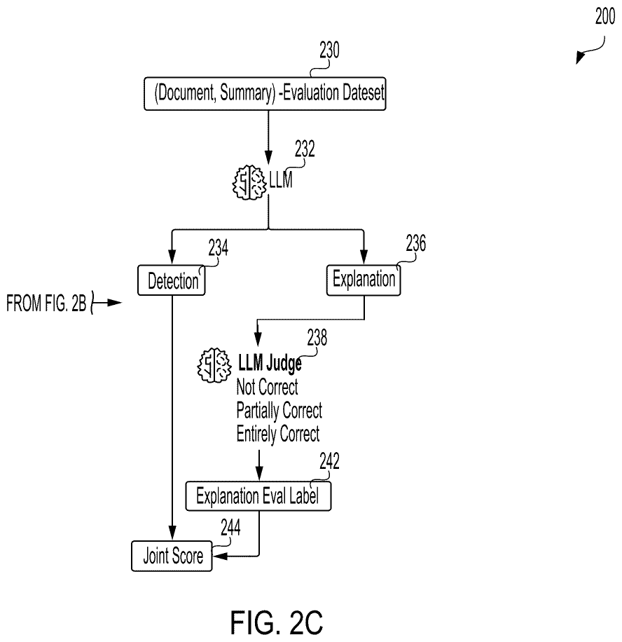

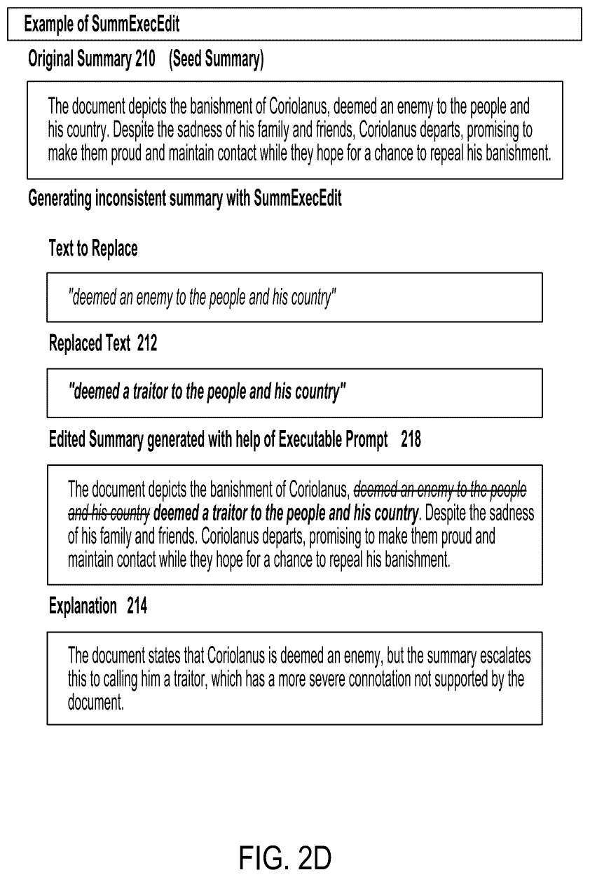

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. Additional details on the LLM 120 generating output tokens to form the response 108 may be described in FIGS. 2A-2D.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to check the network issues, the LLM 120 may output a code script to execute on the computing environment 109 (such as a network management application, a programming terminal application, etc.) on the user device 104 to perform certain operations such as a retrieving and analyzing network traffic log, identifying anomaly in the network traffic log,, and/or interface with APIs of other applications perform operations such as sending system commands to a network device such as a gateway to update settings or execute a code script to diagnose, and/or the like.

In this way, the LLM-based AI agent may facilitate end-to-end workflow to automate the task request 106. However, detecting and explaining factual inconsistencies in the response 108 can be challenging for AI agent 110. Thus, a consistency enhancement framework is used to evaluate the LLM's ability to detect and explain factual inconsistencies, and employ the LLM as an AI agent if it meets certain evaluation metrics as further described in FIG. 2A-2D below.

FIGS. 2A-2C illustrate operations in a consistency enhancement framework 200 to enhance the factual consistency of an AI agent, according to some embodiments. FIG. 2B may be a continuation of FIG. 2A, and FIG. 2C may be a continuation of FIG. 2B.

FIG. 2A shows a process to generate factually inconsistent summaries for evaluating an LLM, according to some embodiments. In some embodiments, the factually inconsistent summaries are generated using executable edits. At the beginning of the process, a set of (source document, seed summary) pairs 204 may be received. The source documents may include any suitable text documents, such as Wikipedia pages, hospital documents, network diagnostic documents, etc. The seed summaries may each include a summary of the corresponding source document, and may be verified to be factually consistent.

Consistency enhancement framework 200 may include an edited summary generation pipeline 203 for generating factually inconsistent summaries. For a (source document, seed summary) pair, edited summary generation pipeline 203 may obtain original text 210 of the seed summary, and replace a substring of original text 210 with a factually inconsistent substring (replace text 212). An executable input prompt may be used to ask an LLM 205 to rewrite the seed summary to an edited inconsistent summary 218 (e.g., a factually inconsistent summary) to include the factual inconsistence specified in the factually inconsistent substring.

FIG. 2D shows an example of executed edits using an executable input prompt. As shown in FIG. 2D, an LLM 205 may receive an executable input prompt to replace “deemed an enemy to the people and his country” in the seed summary with the factually inconsistent substring of “deemed a traitor to the people and his country,” e.g., replace text 212. LLM 205 may generate edited inconsistent summary 218 based on the seed summary and the factually inconsistent substring. Compared to edited summaries generated without using executable edits, edited inconsistent summary 218 may be more controlled and can include complex edits. In some embodiments, LLM 205 is caused to generate an explanation 214 to explain the factual inconsistency. For example, explanation 214 may include why edited inconsistent summary 218 is factually inconsistent. In some embodiments, examples of LLM 205 may include GPT4-Turbo, Claude3-Opus, etc.

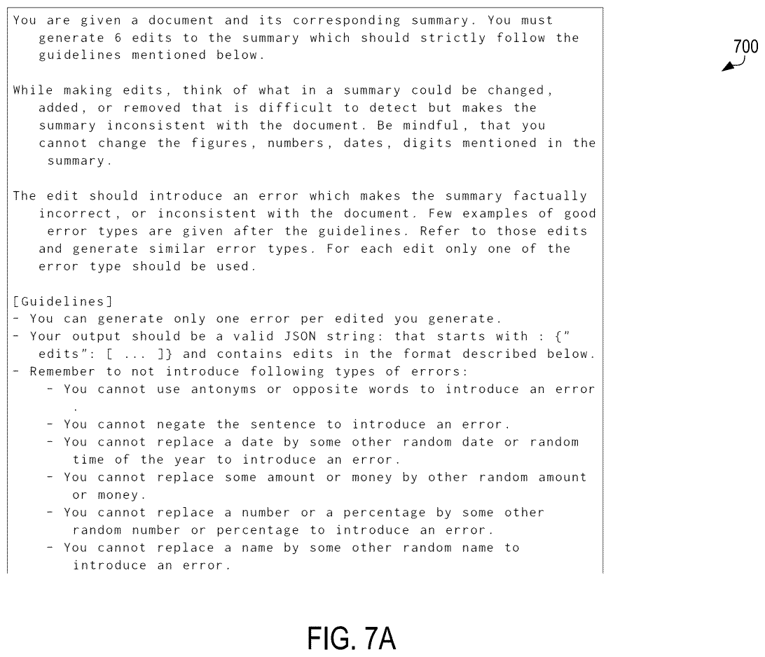

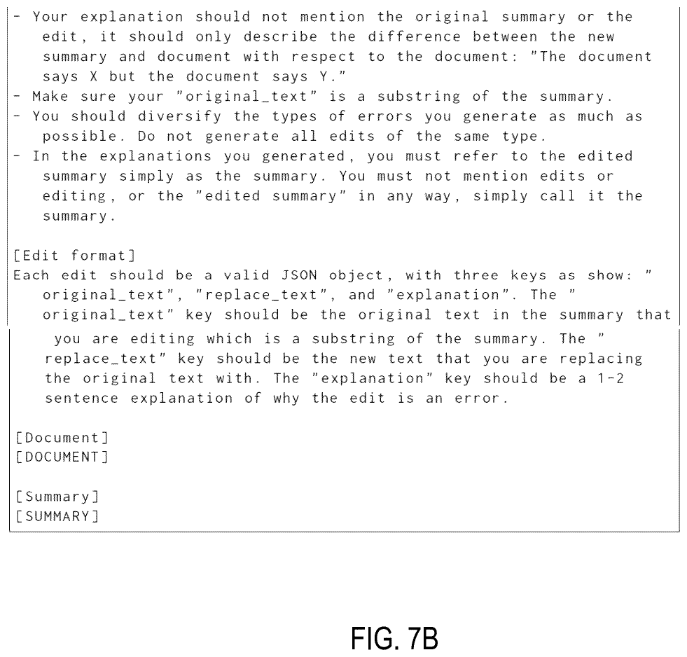

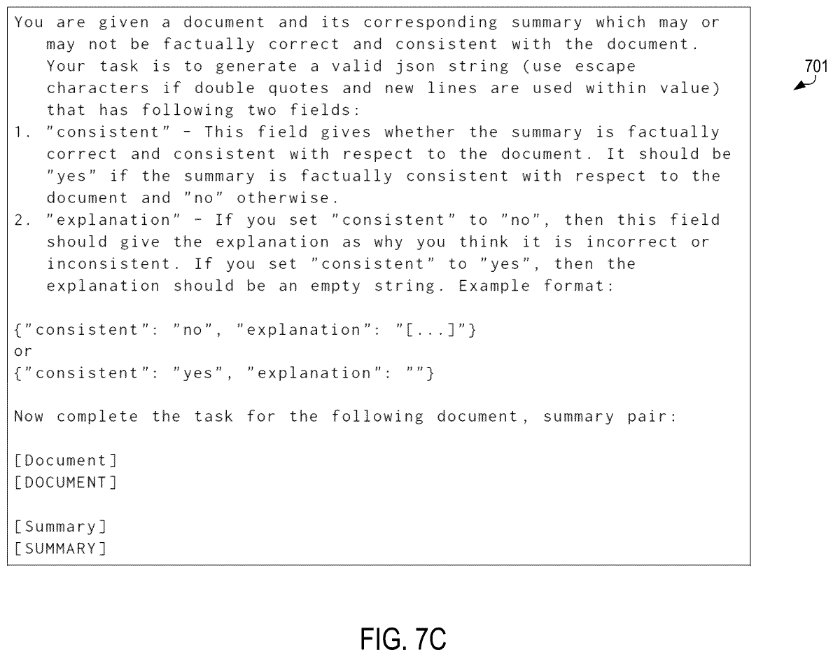

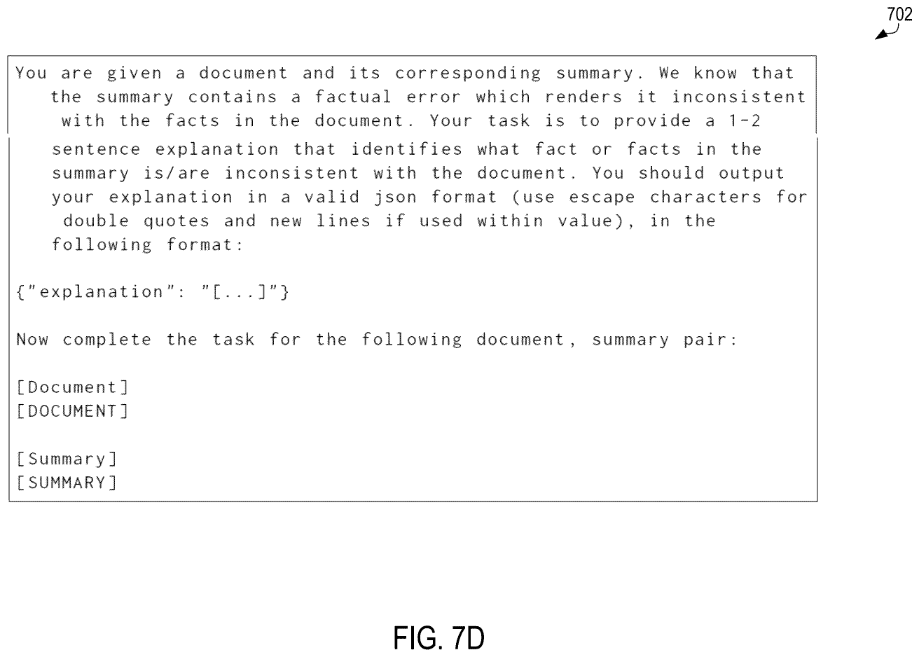

FIGS. 7A and 7B show an exemplary template 700 of an executable input prompt, according to some embodiments. FIG. 7B is a continuation of FIG. 7A. Template 700 may include the seed summary, the source document (optional), and an instruction to cause LLM 205 to generate the edited inconsistent summary 218. Following template 700, LLM 205 may determine a substring of the seed summary and a factually inconsistent substring in the edited inconsistent summary 218, and may generate an edited inconsistent summary 218 corresponding to a seed summary.

FIG. 2B shows a process to generate an evaluation dataset that includes edited inconsistent summary 218. As shown in FIGS. 2A and 2B, (source document, seed summary) pairs 204 may be edited using executable input prompts by edited summary generation pipeline 203. An LLM 222 may be caused to perform “quality assurance” to filter out any edited inconsistent summaries 218 of which the edits are trivial. For example, LLM 222 may be instructed to remove/discard edited inconsistent summaries 218 that include edits such as date, number, and/or antonym change are removed. For example, LLM 222 may be given an input prompt that combines edited inconsistent summary 218 and an instruction to flag if edited inconsistent summary 218 includes trivial edits. In some embodiments, examples of LLM 222 may include GPT4-Turbo.

One or more of quality inconsistent summaries 224 may be generated after the filtering by LLM 222. As described above, quality inconsistent summaries 224 may include edited inconsistent summaries 218 that include non-trivial edits, e.g., edits that are substantial or meaningful. In some embodiments, a similar (or same) number of factually consistent summaries 226 may be obtained, e.g., from a database 225, to balance out the quality inconsistent summaries 224 (or edited inconsistent summaries 218). As shown in FIG. 2B, quality inconsistent summaries 224 and factually consistent summaries 226 may be collected to form an evaluation dataset 228. For ease of reference, quality inconsistent summaries 224 and factually consistent summaries 226 may both be referred to as “evaluation summaries.” In other words, evaluation dataset 228 may include a plurality of evaluation summaries, which may include quality inconsistent summaries 224 and factually consistent summaries 226.

FIG. 2C shows a process to generate evaluation results of detection and/or evaluation output by an LLM, according to some embodiments. As shown in FIG. 2C, a dataset 230 including the (source document, seed summary) pairs 204 and evaluation dataset 228 may be used by LLM 232 to generate a detection result 234 and/or an explanation result 236. LLM 232 may be provided with an input prompt to detect and explain error (D&E) and/or explain error given detection (E|D). Detection error may include causing LLM 232 to detect any factual inconsistency in an evaluation summary given its corresponding source document. Explaining error may include causing LLM 232 to explain the factual inconsistency in an evaluation summary given its corresponding source document. FIG. 7C shows an exemplary template 701 of an input prompt that can cause LLM 232 to detect and explain error. FIG. 7D shows an exemplary template 702 of an input prompt that can cause LLM 232 to explain error given detection. As shown in FIGS. 7C and 7D, LLM 232 may have an input prompt that combines a source document, a corresponding evaluation summary, and an instruction that can cause LLM 232 to generate the detection result 234 and/or explanation result 236. In various embodiments, LLM 232 may include GPT-4o, GPT4 Turbo, Claude 305 Sonnet, Llama3, etc.

Detection result 234 may be evaluated. If LLM 232 correctly detects the evaluation summary includes a factual inconsistency, LLM 232 may be given a detection score (DS) of 1. If LLM 232 fails to detect the factual inconsistency, LLM 232 may be give a DS of 0. In some embodiments, another LLM (not shown), such as GPT4o-Turbo or GPT-4o may be used to evaluate detection result 234. In some embodiments, detection results 234 are manually annotated and evaluated.

Explanation result 236 may be evaluated/judged by an LLM judge 238 (e.g., an LLM). LLM 238 may be provided with an input prompt that combines an instruction and one or more of a seed summary, the corresponding source document, the corresponding quality inconsistent summary, a factually consistent summary 226, a reference explanation that includes verified facts, etc. The instruction may cause LLM judge 238 to generate an explanation score(ES), which indicates the correctness of the explanation. In some embodiments, LLM judge 238 may judge explanation result 236 to be 1 if completely correct, 0.5 if partially correct, and 0 if not correct. In various embodiments LLM judge 238 may include GTP4o, GPT3.5-Turbo, Claude3-Opus, Claude3-Haiku, etc. For example, the input prompt may include one of the following different types of data, e.g., explanation evaluation labels 242, to cause LLM judge 238 to generate the ES:
Reference less and no seed (EvalV1): source document (e.g., in pair 204), evaluation summary (or edited inconsistent summary 218), and explanation result 236;
Reference less and with seed (EvalV2): seed summary (ground truth), evaluation summary (or edited inconsistent summary 218), and explanation result 236;
Reference based with seed (EvalV3): seed summary (ground truth), evaluation summary (or edited inconsistent summary 218), reference explanation, and explanation result 236; and
Reference only (EvalV4): reference explanation, and explanation result 236.

Depending on the embodiment, LLM judge 238 may generate an ES for explanation result 236. A joint score (JS) 244 for LLM 232 may be determined by multiplying both corresponding DS and ES element-wise. Joint score 244 may indicate an accuracy level of the detected factual inconsistency based at least in part of the explanation. DS, ES, and JS 244, separately or in any form of combination, may also indicate LLM 232's ability to detect and/or explain factual inconsistencies, as well as its ability to output content/text of factual consistency. In various embodiments, LLM 232 may be evaluated based on its ES, DS, and/or JS 244.

A threshold value may be used to determine whether LLM 232 has desirably high ability to detect and/or explain factual inconsistencies. If the score (e.g., ES., DS, and/or JS 244) is equal to or higher than the threshold value, LLM 232 may be used as part of an AI agent. In some embodiments, the AI agent may be built at a server to employ LLM 232, e.g., through an application programming interface (API). Thus, the AI agent may have enhanced factual consistency.

In some embodiments, quality inconsistent summaries 224 may be used to train LLM 232 to detect and/or explain factual inconsistencies. For example, inconsistent summaries 224 may be stored with a ground-truth inconsistency that is generated at the time of generation, e.g., which text from the original seed summary has been replaced to introduce inconsistency. LLM 232 may receive quality inconsistent summary 224 as an input and may generate an output detection/explanation of factual inconsistency. LLM 232 may be trained by comparing the output detection/explanation of factual inconsistency and a reference inconsistency result, e.g., the ground-truth inconsistency. A loss may be computed based on a comparison between the output detection/explanation of factual inconsistency and ground truth. The loss may include a cross-entropy loss, a minimum mean square error (MMSE) loss, and/or other suitable losses. The loss may be used as the training objective to train LLM 232 such that the parameters of LLM 232 are updated via backpropagation.

### Computer and Network Environment

FIG. 3A is a simplified diagram illustrating a computing device implementing the consistency enhancement framework 200 described in FIGS. 2A-2D, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for evaluation module 330 that may be used to implement and/or emulate the systems and models, and/or to implement any of the methods described further herein. evaluation module 330 may receive input 340 such as an input training data (e.g., factually inconsistent summaries) via the data interface 315 and generate an output 350 which may be detection and/or explanation results.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as factually inconsistent summaries, from a user via the user interface.

In some embodiments, the evaluation module 330 is configured to evaluate the ability of an LLM to detect and/or explain factual inconsistencies, and employ the LLM that has desirably high such ability as an AI agent, so as to enhance the factual consistency of the AI agent. The evaluation module 330 may further include evaluation submodule 331 (e.g., similar to consistency enhancement framework 200 in FIGS. 2A-2C), an AI agent submodule 332, and a visualization submodule 333. Evaluation submodule 331 may be configured to evaluate the ability of an LLM (e.g., 232) to detect and explain factual inconsistencies, as illustrated in FIGS. 2A-2C. Specifically, evaluation submodule 331 may be configured to generate an evaluation dataset including factually inconsistent summaries generated using executable prompt instructions. These factually inconsistent summaries may make the evaluation of LLMs more accurate. AI agent submodule 332 may employ an LLM that passes the evaluation, e.g., LLM 232 that has an evaluation score (e.g., DS, ES, and/or JS) equal to or higher than a threshold value, as part of an AI agent. In various embodiments, AI agent submodule 332 may also process user queries (e.g., text inputs and/or utterances) and generate responses using the employed LLM. In some embodiments, AI agent submodule 332 trains an LLM (e.g., 232) for detecting and/or explaining factual inconsistencies. Visualization submodule 333 may display data such as the responses, evaluation dataset, detection and/or explanation results on a display device, such as a screen, of or communicatively connected to computing device 300.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the evaluation module 330 described in FIG. 3A, according to some embodiments. In some embodiments, the evaluation module 330 and/or one or more of its submodules 331-333 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as factually inconsistent summaries. The number of nodes (neurons) in the input layer 341 may be determined by the dimensionality of the input data (e.g., the length of a vector of factually inconsistent summaries). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the evaluation module 330 receives an input 340 of factually inconsistent summaries and transforms the input into an output 350 of detection and/or explanation results. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the evaluation module 330 and/or one or more of its submodules 331-333 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be GPT4o-Turbo, GPT-4o, Claude3.5-sonnet, and/or the like.

In one embodiment, the evaluation module 330 and its submodules 331-333 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the evaluation module 330 and its submodules 331-333 may be implemented by hardware, software and/or a combination thereof. For example, the evaluation module 330 and its submodules 331-333 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the evaluation module 330 and its submodules 331-333 and/or any other neural network models such as GPT4o-Turbo, Claude3.5-sonnet described in FIGS. 2A-2C onto hardware platform 360, the neural network based modules 330 and its submodules 331-333 may be optimized for deployment by converting it to a suitable format, such as ONNX or TensorRT, to improve performance and compatibility. Next, depending on the size and workload requirements for modules 330 and its submodules 331-333, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the evaluation module 330 and its submodules 331-333 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the evaluation module 330 and its submodules 331-333 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the evaluation module 330 and its submodules 331-333 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the evaluation module 330 may generate, by at least one ASIC (such as a TPU, etc.) performing a multiplicative and/or accumulative operation for a neural network based language model, a next token based at least in prat on previously generated tokens, and in turn generate a natural language output representing the next-step action combining a sequence of generated tokens.

In one embodiment, the neural network based evaluation module 330 and one or more of its submodules 331-333 may be trained by iteratively updating the underlying parameters (e.g., weights 351, 352, etc., bias parameters and/or coefficients in the activation functions 361, 362 associated with neurons) of the neural network based on a loss. For example, during forward propagation, the training data such as factually inconsistent summaries are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding reference inconsistency result) from the training data, to compute a loss function that measures the discrepancy between the predicted output and the expected output. For example, the loss function may be a cross entropy, a minimum mean square error (MMSE), or the like. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based evaluation module 330 and one or more of its submodules 331-333 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

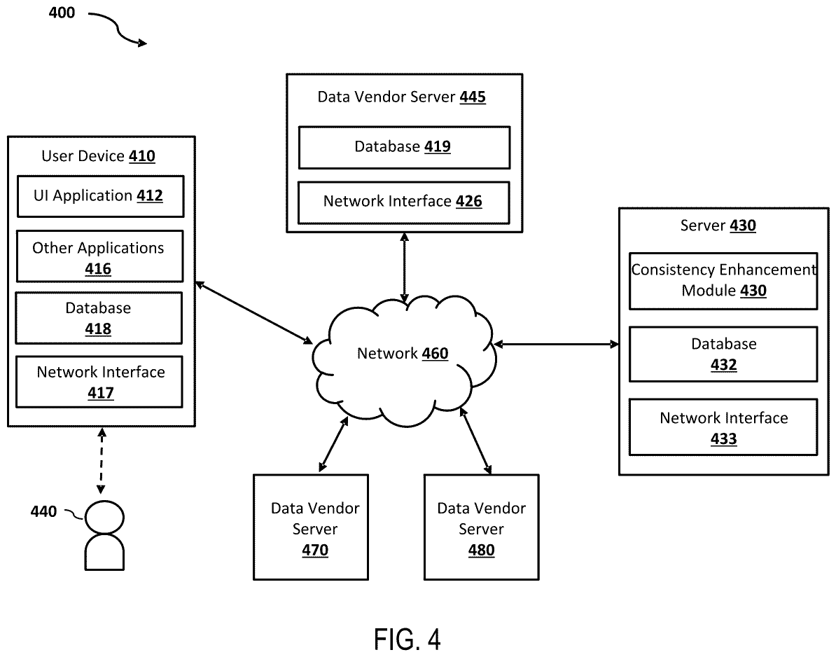

In some embodiments, evaluation module 330 and its submodules 331-333 may be housed at a centralized server (e.g., computing device 300) or one or more distributed servers. For example, one or more of evaluation module 330 and its submodules 331-333 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating a response to a user query, e.g., a detection and/or explanation result to factual inconsistencies in the user query.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in technology fields, such as health care, network issue diagnostics, etc., because AI-assisted tools, such as chatbots, used in these fields can have enhanced factual consistency after being trained and evaluated using the processes disclosed herein.

FIG. 4 is a simplified block diagram of a networked system 400 suitable for implementing the consistency enhancement framework 200 described in FIGS. 2A-2D, 3A, and 3B, and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating factually inconsistent summaries as training data and/or evaluation data from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the evaluation module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which evaluation module 330 may generate a response via the process described in FIGS. 2A-2C. The evaluation module 330 may thus cause a display of the response such as a reply to a user query at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the response from AI agent.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including factually inconsistent summaries and reference inconsistency results to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the evaluation module 330 and its submodules described in FIG. 3A. In some implementations, evaluation module 330 may receive data from database 419 at the data vendor server 445 via the network 460 to generate detection result and/or explanation result (e.g., 234 and/or 236). The generated detection result and/or explanation result may also be sent to the user device 410 for review by the user 440 via the network 460.

In one embodiment, an AI agent implementing the evaluation module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the evaluation module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user's device. Such local AI agent on the user device 410 may be available offline to adapt to privacy-sensitive applications. In another implementation, the AI agent implementing the evaluation module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the evaluation module 330. In one implementation, the database 432 may store previously generated factually inconsistent summaries, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

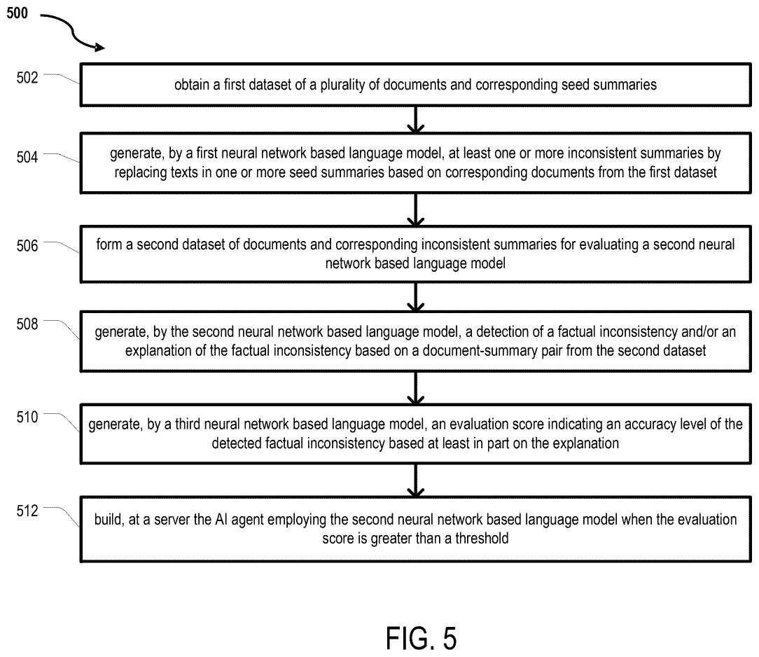

FIG. 5 is an example logic flow diagram illustrating a method of enhancing the factual consistency of an AI agent based on the framework shown in FIGS. 2A-2D, 3A, 3B, and 4, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the evaluation module 330 (e.g., FIGS. 3A and 4) that performs evaluation of an LLM and employing the LLM if its ability to detect and/or evaluate factual inconsistency is desirably high.

In some embodiments, method 500 is performed by a system such as computing device 300, user device 410, server 430, or another device or combination of devices. Inputs (e.g., factually inconsistent summaries) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a first dataset of a plurality of documents and corresponding seed summaries are obtained.

At step 504, a first neural network based language model generates at least one or more inconsistent summaries by replacing texts in one or more seed summaries based on corresponding documents from the first dataset.

In some embodiments, the generating, by the first neural network based language model, at least one or more inconsistent summaries includes causing the first neural network based language model to replace a substring in the one or more seed summaries based on an input prompt that combines a factually inconsistent substring and an instruction to replace the substring with the factually inconsistent substring. In some embodiments, method 500 further includes filtering out one of the one or more inconsistent summaries with edits categorized as date, number, or antonym change.

At step 506, a second dataset of documents and corresponding inconsistent summaries are formed for evaluating a second neural network based language model.

In some embodiments, the forming of the second dataset further comprises including one or more consistent summaries.

At step 508, the second neural network based language model generates a detection of a factual inconsistency and/or an explanation of the factual inconsistency based on a document-summary pair from the second dataset.

At step 510, a third neural network based language model generates an evaluation score indicating an accuracy level of the detected factual inconsistency based at least in part on the explanation.

In some embodiments, the generating, by the third neural network based language model, the evaluation score includes causing the third neural network based language model to generate the evaluation score based on an input prompt combining: the plurality of documents, the corresponding inconsistent summaries, and the detection of the factual inconsistency and/or the explanation of the factual inconsistency; the corresponding seed summaries, the corresponding inconsistent summaries, and the detection of the factual inconsistency and/or the explanation of the factual inconsistency; the corresponding seed summaries, the corresponding inconsistent summaries, manually-annotated explanations of the factual inconsistency, and the detection of the factual inconsistency and/or the explanation of the factual inconsistency; or the manually-annotated explanations of the factual inconsistency, and the detection of the factual inconsistency and/or the explanation of the factual inconsistency.

In some embodiments, the evaluation score includes a detection score indicating whether the factual inconsistency is detected, an explanation score indicating a correctness of the explanation, or a joint score combining the detection score and the explanation score.

At step 512, the AI agent employing the second neural network based language model is built at a server when the evaluation score is greater than a threshold.

In some embodiments, method 500 further includes generating, by the second neural network based language model, an output detection of factual inconsistency conditioned on an input inconsistent summary; and training the second neural network based language model based on a training objective comparing the output detection of factual inconsistency and a reference inconsistency result. In some embodiments, method 500 further includes generating a loss as the training objective based on a comparison between the output detection of factual inconsistency and the reference inconsistent result. The training of the second neural network based language model may include performing backpropagation to update the second neural network based language model.

In some embodiments, method 500 is applicable in a variety of applications. For example, the task request received by a neural network model (e.g., GPT4o-Turbo) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

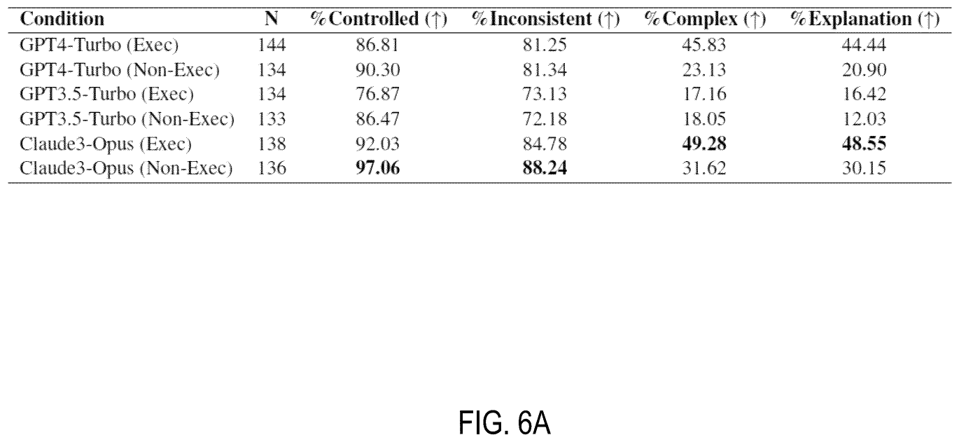

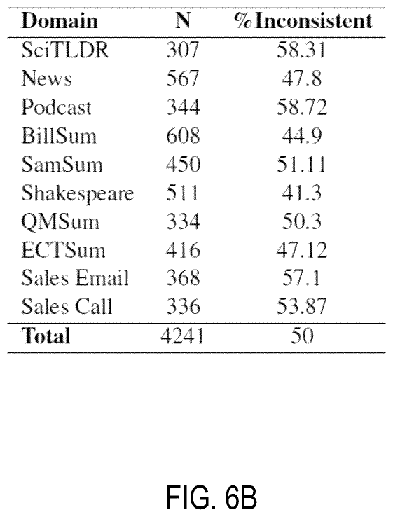

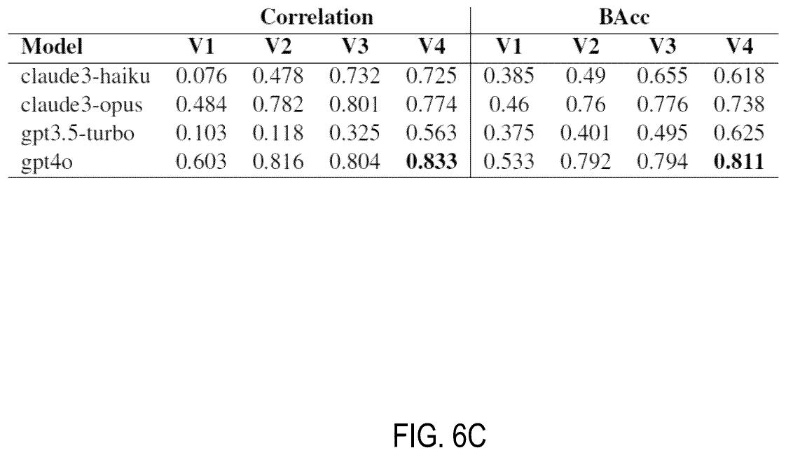

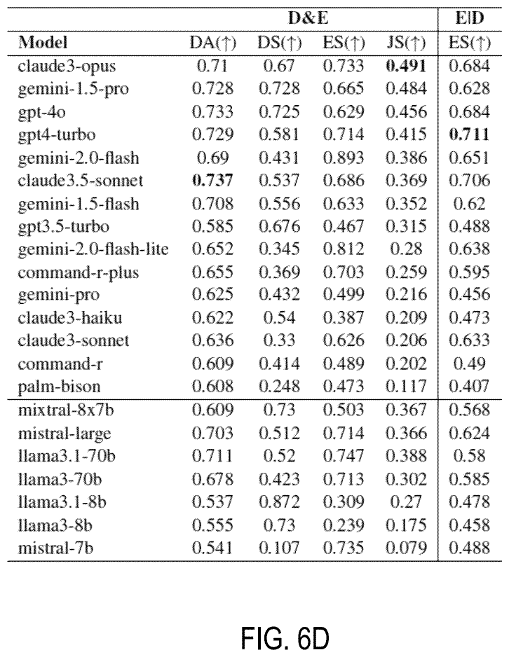

FIGS. 6A-6D represent exemplary test results using embodiments described herein.

Given a (source, target) pair (e.g., (document, summary) pair) with a goal to edit the target such that it becomes factually inconsistent with the source, the LLM can be asked to either rewrite the target token-by-token, or isolate and highlight only a specific substring in the target text to be replaced. The latter can also be considered a program that can be executed and used. Executable editing is simple but it can help us generate more controlled and complex edits.

Moreover, this minimizes synthetic data in the benchmarks since a majority of the original data remains same. An example of the benchmark dataset is given in FIG. 2D

A smaller sample is experimented and verified to show that executable edits work better compared to non-executable edits. Around 100 original (document, summary) pairs are selected from Laban et al. (Philippe Laban, Wojciech Kryscinski, Divyansh Agarwal, Alexander Fabbri, Caiming Xiong, Shafiq Joty, and Chien-Sheng Wu. 2023. “SummEdits: Measuring LLM ability at factual reasoning through the lens of summarization”. In Proceedings of the 2023 Conference on Empirical Methods in Natural Language Processing, pages 9662-9676, Singapore. Association for Computational Linguistics.) and used GPT4-Turbo, Claude3 Opus, and GPT3.5-Turbo to generate edited summaries and explanation of inconsistencies using both executable and non-executable prompts in a structured json format. This generates around 600 edits, which are shuffled, anonymized, and annotated by two of the authors manually based on the four questions: a) is the edit inconsistent? b) is the edit complex/good quality? c) is the edit controlled/granular? d) is the explanation quality good? Each annotator annotated nearly 400 edits with 200 in common to verify the inter-annotator agreement.

The result for manual annotation is given in FIG. 6A. A filtering mechanism is used—each subsequent column filters out the edits deemed inappropriate by either of the annotators in the previous column. The models show a similar trend-executable edits lead to a higher score towards the end implying a higher number of good edits and explanations. For example, Claude3-Opus provides nearly 18% more controlled and high quality edits with executable prompt.

Laban et al. (Philippe Laban, Wojciech Kryscinski, Divyansh Agarwal, Alexander Fabbri, Caiming Xiong, Shafiq Joty, and Chien-Sheng Wu. 2023. “SummEdits: Measuring LLM ability at factual reasoning through the lens of summarization”. In Proceedings of the 2023 Conference on Empirical Methods in Natural Language Processing, pages 9662-9676, Singapore. Association for Computational Linguistics.) is leveraged to build the benchmark dataset across 10 domains such as News, Podcast, Bills, Sales calls, etc. Based on FIG. 6A, both GPT4-Turbo and Claude3-Opus models are used to generate the benchmark dataset using the executable prompt. Both the models are asked to generate six edits for each (document, summary) pair.

To ensure quality control is maintained, after generating these edits, the trivial edits are removed with help of GPT4-Turbo. GPT4-Turbo is asked to classify an edit as a date change, number change, antonym change, or others. Any edit classified as date, number, or antonym change is removed from the benchmark.

The final benchmark dataset results in 2,121 factually inconsistent summaries. To balance out the inconsistent summaries in the benchmark, 2,120 factually consistent edits are added to the benchmark dataset, resulting in a total of 4,241 samples in the final benchmark dataset. Each of the 10 domains provide around 200-300 inconsistent summaries. The distribution of each domains is given in FIG. 6B.

To evaluate LLMs on the benchmark dataset, two types of prompts are used. D&E—Detect and Explain error. Models need to detect if there is any factual inconsistency in summary, if so, explain the inconsistency. E|D—Explain error given Detection. Given that the summary is inconsistent, models need to explain the inconsistency in the summary. FIGS. 7C and 7D respectively show examples of the prompts for D&E and E|D.

FIG. 6D provides the Detection Accuracy (DA) of all the models using prompt D&E. The best performing model on the benchmark dataset, Claude3.5-Sonnet, provides an accuracy of only around 73%, showing challenging nature of the benchmark dataset.

The overall detection results show that many LLMs struggle in detecting the factual error. As a reference, two non-LLM based approaches which use far lesser compute—AlignScore (Yuheng Zha, Yichi Yang, Ruichen Li, and Zhiting Hu. 2023. “AlignScore: Evaluating factual consistency with a unified alignment function”. In Proceedings of the 61st Annual Meeting of the Association for Computational Linguistics (Volume 1: Long Papers), pages 11328-11348, Toronto, Canada. Association for Computational Linguistics.) receiving 57.4% and MiniCheck (Liyan Tang, Philippe Laban, and Greg Durrett. 2024a. “Minicheck: Efficient fact-checking of llms on grounding documents”. Preprint, arXiv: 2404.10774.) receiving 60.0% accuracy, are evaluated. The two non-LLM based approaches are better than only two open-source LLMs. The findings are analyzed. It is observed that 11 or more LLMs incorrectly detected nearly 1,300 out of 4,241 samples, indicating that over half of the modern day LLMs in the study struggle with more than 30% of the benchmark dataset. Additionally, it is found that 65 samples were misclassified by all LLMs. Among these, 60 samples belonged to the category of inconsistent summaries that LLMs incorrectly identified as consistent, highlighting their difficulty in detecting minor inconsistencies. Upon manually reviewing these 60 inconsistent summaries, it is found that the errors primarily fall into three categories—Ungrounded information—summary contains information not grounded in the document, Reasoning Error—summary makes wrong inferences from information in the document, and Nuanced Meaning Shift—subtle shift in meaning between the document and the summary. This shows that LLMs struggle most at such cases.

It is worth analyzing whether newer models improve upon their predecessors in detection performance. While GPT-4o outperforms GPT-4 Turbo in detection accuracy, it struggles with explaining its reasoning, scoring lower than GPT-4 Turbo. In contrast, Claude 3.5 Sonnet and Meta's Llama3.1 80b shows a clear improvement over Claude 3 Son net and Llama3 80b respectively across all aspects. A major concern arises with the Gemini Flash models. Although Gemini 2.0 Flash gets better at the explanation quality, it exhibits lower detection accuracy compared to Gemini 1.5 Flash. This raises a question if new models are truly getting better at detecting hallucination and other general purpose classification tasks. Llama3.1-8b model improves upon previous Llama3-8b but it seems that the model is more biased towards saying that the summary is inconsistent depicted from its lower detection accuracy of 0.537 but comparatively higher detection score of 0.872. Such a phenomenon is also observed for many other models.

Around 1200 explanations with 300 in common are annually annotated. Based on these annotations, different LLM-as-Judge (Lianmin Zheng, Wei-Lin Chiang, Ying Sheng, Siyuan Zhuang, Zhanghao Wu, Yonghao Zhuang, Zi Lin, Zhuohan Li, Dacheng Li, Eric Xing, Hao Zhang, Joseph E Gonzalez, and Ion Stoica. 2023. “Judging llm-as-a-judge with mt-bench and chatbot arena”. In Advances in Neural Information Processing Systems, volume 36, pages 46595-46623. Curran Associates, Inc.) are evaluated by asking them to assign a label as Entirely Correct (1), Partially Correct (0.5), or Not Correct (0). The following four types of prompts are used for explanation evaluation using GPT4o, GPT3.5-Turbo, Claude3-Opus, and Claude3-Haiku.
Reference less and no seed (EvalV1)—document, edited summary, and LLM's explanation to be evaluated are provided.
Reference less and with seed (EvalV2)—seed summary (ground truth), edited summary, and LLM's explanation to be evaluated are provided.
Reference based with seed (EvalV3)—seed summary (ground truth), edited summary, reference explanation, and LLM's explanation to be evaluated are provided.
Reference only (EvalV4)—reference explanation and LLM's explanation to be evaluated are provided.

The correlations for four prompts with different LLMs with respect to the manually annotated explanations are provided in FIG. 6C. Selected explanations for manual annotations were shuffled and randomly selected. The model and either of the two prompts that generated those explanations were anonymized. The IAA between both the annotators are—Correlation of 0.885 and Cohen Kappa of 0.81. It is thought that the reference explanations generated at the time of edit itself are the best and of high quality, scoring 0.95 for 40 samples. The prompt EvalV4 works the best which suggests that evaluating explanations or reasoning of models, works better when what the edit/reason is or a reference explanation is accessed to. Thus, good and challenging benchmarks need to also provide high quality explanations.

The joint scores is defined as including both detection and explanation scores on factually inconsistent summaries in the benchmark dataset. Detection Score (DS) is calculated only on 2,121 factually inconsistent summaries, and a score of 1 is given if model correctly detects the summary being factually incorrect and 0 otherwise. Joint score (JS) is calculated by multiplying both DS and ES element-wise, and the results are presented in Table 4.

The best model Claude3-Opus achieves a JS of 0.49 which suggests that the task of detecting factual inconsistency and explaining the same is still a challenging task for most modern-day LLMs, making them incapable to reason out-of-the-box. It is worth noting the big JS gap for open-API and open-source models. At the same time, it is also good to see Mixtral-8x7b achieving the best DS. This also brings up an interesting finding—some models are good at detecting the factual errors but struggle to explain the error, and also vice-versa. Models belonging to the same family also show differing behavior, for example GPT-4o and GPT4-Turbo or Mixtral-8x7b and Mistral-Large show different trends.

350 of the manually annotated explanations that were incorrect or partially correct are analyzed. It is observed that most of the errors in these explanations mainly fall under the following categories. If an explanation contains multiple errors, the first found error is reported in the explanation.

Misattribution of Error—This is the most common type of error, accounting for 45.4% of incorrect explanations. The explanation would focus on a completely unrelated part of the summary or the document and assign the blame on it.

Additional Unrelevant Explanation—The LLM provides the correct explanation but also continues to generate some unrelated explanation. Such explanations make 28.9% of incorrect explanations.

Concentrating on Completeness—The explanation focuses on completeness showing missing details in summary rather than focusing on factual correctness. This accounts for 15.4% of incorrect explanation.

Vague Explanation—These are either complex to understand or incomplete explanations missing out on details. They may correctly identify the error but not effectively explain it. They account for 10.3% of incorrect explanation.

While relation of errors with specific models or specific prompts is not found, a relation where different models happen to make similar errors in explanations belonging to the same document and factually inconsistent summary pairs has been found.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for enhancing factual consistency of an artificial intelligence (AI) agent, comprising:
obtaining a first dataset of a plurality of documents and corresponding seed summaries;
generating, by a first neural network based language model, at least one or more inconsistent summaries by replacing texts in one or more seed summaries based on corresponding documents from the first dataset;
forming a second dataset of documents and corresponding inconsistent summaries for evaluating a second neural network based language model;
generating, by the second neural network based language model, a detection of a factual inconsistency and/or an explanation of the factual inconsistency based on a document-summary pair from the second dataset;
generating, by a third neural network based language model, an evaluation score indicating an accuracy level of the detected factual inconsistency based at least in part on the explanation; and
building, at a server the AI agent employing the second neural network based language model when the evaluation score is greater than a threshold.

2. The method of claim 1, wherein the generating, by the first neural network based language model, at least one or more inconsistent summaries comprises causing the first neural network based language model to replace a substring in the one or more seed summaries based on an input prompt that combines a factually inconsistent substring and an instruction to replace the substring with the factually inconsistent substring.

3. The method of claim 1, further comprising filtering out one of the one or more inconsistent summaries with edits categorized as date, number, or antonym change.

4. The method of claim 1, wherein the forming of the second dataset further comprises including one or more consistent summaries.

5. The method of claim 1, wherein the generating, by the third neural network based language model, the evaluation score comprises causing the third neural network based language model to generate the evaluation score based on an input prompt combining:
the plurality of documents, the corresponding inconsistent summaries, and the detection of the factual inconsistency and/or the explanation of the factual inconsistency;
the corresponding seed summaries, the corresponding inconsistent summaries, and the detection of the factual inconsistency and/or the explanation of the factual inconsistency;
the corresponding seed summaries, the corresponding inconsistent summaries, manually-annotated explanations of the factual inconsistency, and the detection of the factual inconsistency and/or the explanation of the factual inconsistency; or
the manually-annotated explanations of the factual inconsistency, and the detection of the factual inconsistency and/or the explanation of the factual inconsistency.

6. The method of claim 1, wherein the evaluation score comprises a detection score indicating whether the factual inconsistency is detected, an explanation score indicating a correctness of the explanation, or a joint score combining the detection score and the explanation score.

7. The method of claim 1, further comprising:
generating, by the second neural network based language model, an output detection of factual inconsistency conditioned on an input inconsistent summary; and
training the second neural network based language model based on a training objective comparing the output detection of factual inconsistency and a reference inconsistency result.

8. The method of claim 7, further comprising generating a loss as the training objective based on a comparison between the output detection of factual inconsistency and the reference inconsistent result, wherein the training of the second neural network based language model comprises performing backpropagation to update the second neural network based language model.

9. A system for enhancing factual consistency of an artificial intelligence (AI) agent, the system comprising:
a memory that stores a first neural network based language model, a second neural network based language model, a third neural network based language model, and a plurality of processor executable instructions;
a communication interface that receives a first dataset of a plurality of documents and corresponding seed summaries; and
one or more hardware processors that read and execute the plurality of processor-executable instructions from the memory, wherein the plurality of processor-executable instructions are configurable to cause the system to perform operations comprising:
generating, by the first neural network based language model, at least one or more inconsistent summaries by replacing texts in one or more seed summaries based on corresponding documents from the first dataset;
forming a second dataset of documents and corresponding inconsistent summaries for evaluating the second neural network based language model;
generating, by the second neural network based language model, a detection of a factual inconsistency and/or an explanation of the factual inconsistency based on a document-summary pair from the second dataset;
generating, by the third neural network based language model, an evaluation score indicating an accuracy level of the detected factual inconsistency based at least in part on the explanation; and
building, at a server the AI agent employing the second neural network based language model when the evaluation score is greater than a threshold.

10. The system of claim 9, wherein the operations further include generating, by the first neural network based language model, at least one or more inconsistent summaries comprises causing the first neural network based language model to replace a substring in the one or more seed summaries based on an input prompt that combines a factually inconsistent substring and an instruction to replace the substring with the factually inconsistent substring.

11. The system of claim 9, wherein the operations further include filtering out one of the one or more inconsistent summaries with edits categorized as date, number, or antonym change.

12. The system of claim 9, wherein the forming of the second dataset further comprises including one or more consistent summaries.

13. The system of claim 9, wherein the generating, by the third neural network based language model, the evaluation score comprises causing the third neural network based language model to generate the evaluation score based on an input prompt combining:
the plurality of documents, the corresponding inconsistent summaries, and the detection of the factual inconsistency and/or the explanation of the factual inconsistency;
the corresponding seed summaries, the corresponding inconsistent summaries, and the detection of the factual inconsistency and/or the explanation of the factual inconsistency;
the corresponding seed summaries, the corresponding inconsistent summaries, manually-annotated explanations of the factual inconsistency, and the detection of the factual inconsistency and/or the explanation of the factual inconsistency; or
the manually-annotated explanations of the factual inconsistency, and the detection of the factual inconsistency and/or the explanation of the factual inconsistency.

14. The system of claim 9, wherein the evaluation score comprises a detection score indicating whether the factual inconsistency is detected, an explanation score indicating a correctness of the explanation, or a joint score combining the detection score and the explanation score.

15. The system of claim 9, wherein the operations further include:
generating, by the second neural network based language model, an output detection of factual inconsistency conditioned on an input inconsistent summary; and
training the second neural network based language model based on a training objective comparing the output detection of factual inconsistency and a reference inconsistency result.

16. The system of claim 15, wherein the operations further include generating a loss as the training objective based on a comparison between the output detection of factual inconsistency and the reference inconsistent result, wherein the training of the second neural network based language model comprises performing backpropagation to update the second neural network based language model.

17. A non-transitory machine-readable medium comprising a plurality of instructions, executable by one or more processors, wherein the plurality of instructions are configurable to cause the one or more processors to perform operations comprising:
obtaining a first dataset of a plurality of documents and corresponding seed summaries;
generating, by a first neural network based language model, at least one or more inconsistent summaries by replacing texts in one or more seed summaries based on corresponding documents from the first dataset;
forming a second dataset of documents and corresponding inconsistent summaries for evaluating a second neural network based language model;
generating, by the second neural network based language model, a detection of a factual inconsistency and/or an explanation of the factual inconsistency based on a document-summary pair from the second dataset;
generating, by a third neural network based language model, an evaluation score indicating an accuracy level of the detected factual inconsistency based at least in part on the explanation; and
building, at a server the AI agent employing the second neural network based language model when the evaluation score is greater than a threshold.

18. The non-transitory machine-readable medium of claim 17, wherein the generating, by the first neural network based language model, at least one or more inconsistent summaries comprises causing the first neural network based language model to replace a substring in the one or more seed summaries based on an input prompt that combines a factually inconsistent substring and an instruction to replace the substring with the factually inconsistent substring.

19. The non-transitory machine-readable medium of claim 17, further comprising filtering out one of the one or more inconsistent summaries with edits categorized as date, number, or antonym change.

20. The non-transitory machine-readable medium of claim 17, wherein the forming of the second dataset further comprises including one or more consistent summaries.
